(19) United States
(12) Patent Application Publication
(10) Pub. No.: US 2016/0021102 A1
(43) Pub. Date: Jan. 21, 2016

(54) METHOD AND DEVICE FOR AUTHENTICATING PERSONS

(71) Applicant: Christian PALM, Delbrück (DE)

(72) Inventor: Christian Palm, Delbrueck (DE)

(21) Appl. No.: 14/772,953

(22) PCT Filed: Mar. 3, 2014
(86) PCT No.: PCT/DE2014/100073

§ 371 Date: Sep. 4, 2015

(30) Foreign Application Priority Data
Mar. 4, 2013 (DE) 10 2013 102 092.5

(51) Int. Cl. H04L 29/06

(52) U.S. Cl. CPC H04L 63/0838

(57) ABSTRACT

A method for authenticating a person with respect to a host. The host requests a temporary password from the person for accessing a service of the host. Random-based information is generated and provided to the person via a communication device as an input value for an algorithm from which the temporary password is calculated. The same algorithm is used by the person and by the host in order to calculate the password, and after a match is determined between the password calculated by the person and by the host, the person is granted access to the service of the host. The random-based information is displayed to the person as part of a password request routine of the host, and the person responds by inputting a temporary password. The random-based information is used solely as an input variable for the secret algorithm which ascertains the temporary password.

The invention relates to a method for authenticating a person with respect to a host, wherein the host requires a temporary password from the person requesting a service before accessing the service of the host, wherein a random-based information is generated, which is made available to the person via a communication device as an input value for an algorithm, from which the temporary password is calculated, wherein the same algorithm is applied by the person and the host to calculate the password, and wherein after determination of conformity of the password between the person and the host, the person is given free access to the service of the host.

Furthermore, the invention relates to a device for authenticating persons to a host, with a processor, by means of which in the host an algorithm is applied to the random-based information for calculating a temporary password.

EP 1604257 B1 describes a method for authenticating a person with respect to a host, according to which for access to a service of the host by a person, a predetermined algorithm must be applied to a random number transmitted from the host to the person. The algorithm used for this must be stored in a terminal of the person, for example, in the personal computer. The algorithm calculated from input parameters, such as the random number, a number of previous connections and other parameters, a temporary password, which is then returned to the host. In the host there occurs a parallel calculation of the temporary password based on the input parameters, so that upon confirmation of the correspondence with the temporary password calculated by the person access to the service is enabled. This has the disadvantage that due to the scope of the algorithm, the authentication is relatively involved. It is also known that for access to functions or sharing of a terminal a personal identification number (PIN) known to the person be entered in an input/output unit (I/O unit) and compared by the host with a stored secret code supplied by the person. If they match, access to the function of the terminal is granted. Here, however, the problem arises that the unchangeable identification number can be spied by a third party during entering into the I/O unit, and used for inappropriate purposes.

Object of the present invention is therefore to provide a method and a device for authenticating a person with respect to a host in such a way that the security of the input of a secret information is further improved.

To achieve this object, the invention with the preamble of claim 1 is characterized in that the random-based information as part of a password request routine of the host is displayed to the person, and that person responds with the input of a temporary password, wherein the random-based information is used exclusively as an input variable for the temporary password determining secret algorithm.

According to the invention, a random-based information provided by a host to a person is used exclusively by applying an algorithm to determine a password, which after validation by comparison by the host with a password a calculated in the same manner by the host, enables to the person services of the host. According to the invention, only the algorithm is thus applied to the transmitted random-based information to calculate the access enabling password. The invention is based on the assumption that the secret algorithm used is known only to the host and the person. Spying third persons do not benefit from a knowledge of the entered password, if in the next password request routine another random-based information is provided. This would entail a determination of another password by itself. The password sent to the host is therefore typically temporary and will change if the host changes the host-provided random based information.

According to a preferred embodiment of the invention, the person shall be notified of the algorithm as a secret password determination procedure in the context of identification and/or conclusion of a contract with respect to the host service before using the host service. In comparison to known authentication or identification routines, the person does not have a fixed number or combination of characters, but rather must remember a predetermined fixed password determination routine or rule.

According to a preferred development of the invention, the random-based information from the host is changed depending on the time and/or the person. This change can also be done randomly. This ensures that the same person does not obtain same random-based information multiple times from the host. A spying of the entered password would thus not lead to an abuse of the services intended for the person.

To achieve the object, the invention in conjunction with the preamble of claim 6 is characterized in that the algorithm is already known by the person as a secret password determination rule, and that the password determination rule is chosen such that the temporary password obtained using the password determination rule is determined solely from the random-based information.

The advantage of the invention is in particular that, by providing a secret password determination rule or instruction that is known to only the person and the host, a temporary password can be determined from the random-based information provided by the host, which varies usually at each authentication. A spying of the inputted temporary password by a third party would therefore not lead to a re-authentication access to the services of the host. The basic idea of the invention is that the person is assigned from the host a secret password determination rule, instead of a secret password as it is known from the prior art. According to the invention it is ensured, at virtually any authentication process another temporary password is determined to, since the randomly-related information provided by the host has changed.

According to a development of the invention, the password determination rule is freely selectable and based on numeric or alphanumeric characters, which preferably has such a level of simplicity, that the rule is available to the person from memory or by reading from an information carrier. For example, the host can provide password determination rules in different security levels, from which the person may selects an appropriate one.

According to a further development of the invention, the password determination rule is chosen so that the calculated temporary password has a maximum length of four alphanumeric or numeric characters. Advantageously, in this way the effort required by the person for entry can be limited. For example, the password may have a length of three alphanumeric or numeric characters.

According to a development of the invention, each person is assigned a single password determination rule. Even in the case that more than one person is assigned the same password determination rule, the delivery of the random-based information by the host, which is preferably changed for each request randomly, ensures a high level of security.

According to a further development of the invention, the I/O unit can be integrated in a terminal or in a terminal device, such as a personal computer, a mobile phone or an ATM. The invention can be used anywhere where access to or sharing of secured information or services should be protected by entering a password.

According to a development of the invention, the password determination rule is formed by selecting one or more characters from the random-based information and/or by applying a mathematical rule to one or more characters from the strings of random-based information. The person thus need not remember any combination of numbers, but only the relatively simple password determination rule that is applied to the random-based information. The password determination rule may provide the simplest case, that the person determines the temporary password from the case-specific information, in that one or more characters at a specific location of the random-based information is used.

According to a further development of the invention, in addition an alarm rule is applied to the random-based information, which depends on the password determination rule. Using the alarm rule an alarm password can be generated from the randomly-related information, which is compared with an alarm password determined according to the same alarm rule from the transmitted random-information after entering into the I/O unit of the terminal and sending them to the host, such that if they match then the terminal at which the person is located is blocked. Advantageously, therefore, an ATM is blocked by a person if that person has a reasonable suspicion that they have been fraudulently spied on by another person. The alarm rule may be constructed with e.g. a certain order, for example, by a reverse order of the temporary password.

According to a development of the invention, the random based information sent from the host to the person in response to a request of the same can be formed such that from it, using a user-specific authenticity provision, an authenticity result is additionally determined, so in accordance with a predetermined authenticity result, the authenticity of the host towards the person is established. Advantageously, therefore, the random-based information includes an authenticity feature specific to an individual or person, so that the person in the context of the authentication process can determine the authenticity or the authorization of the host at the same time. If the person applies the authenticity provision to the transmitted random-based information, so the person can immediately determine the authenticity result. In accordance with the predetermined authenticity result, they know that the host is “real” and can then gain access to the desired service of the host by entering the temporary password. This authenticity routine may advantageously be used to in a data network (e.g., internet) to protect the user from Trojans, and to conclude legally binding agreements with another person. Since the authenticity can be determined before entering and submitting the temporary password to the host, the disclosure of security-related information to the “not real” host can be securely prevented.

According to a development of the invention, the request of the person to the host to provide the random-based information is carried out with an integrated authenticity feature by transmitting a user identification. The host will then make available to the user the random-based information using the user-specific authenticity feature in this random-based information. Under the authenticity feature, the user-related authenticity rule is understood, which is applied to the random-based information. The person can in this way quickly and easily determine the authenticity of any communication partners.

Embodiments of the invention will be illustrated in more detail below with reference to drawings.

There is shown:

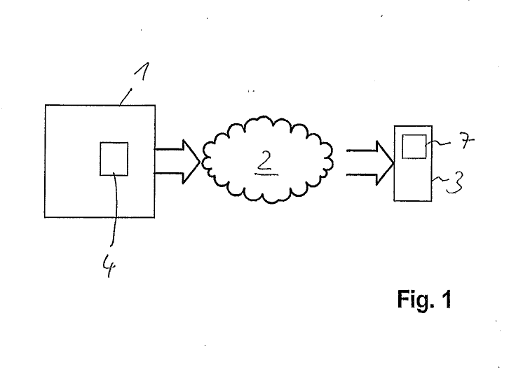

FIG. 1 is a schematic representation of an authentication device,

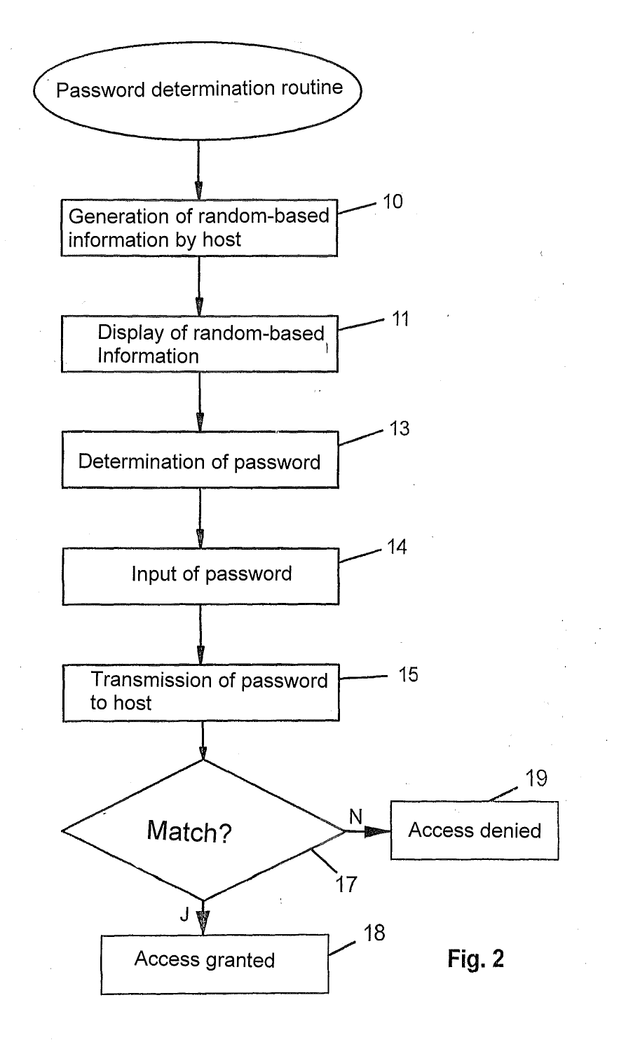

FIG. 2 is a flowchart illustrating a password determination routine,

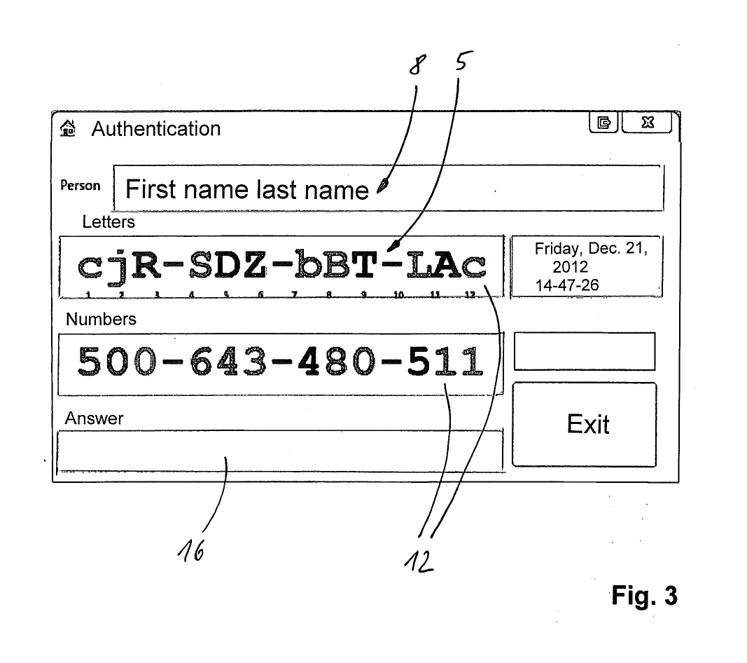

FIG. 3 shows a variant of a display of an I/O unit for entry of a temporary password and

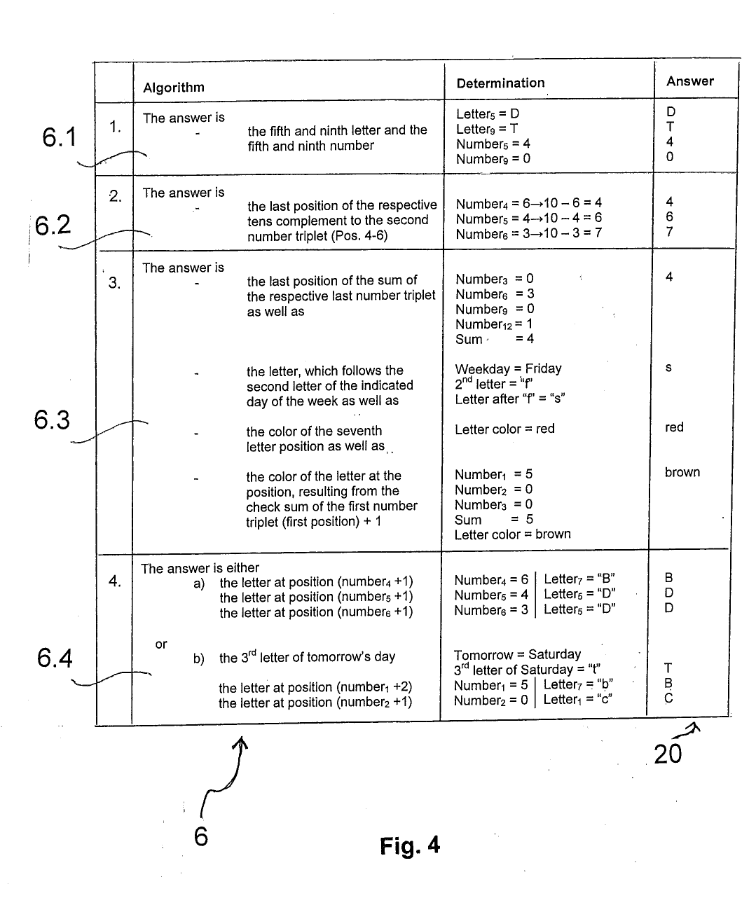

FIG. 4 is a list of possible password determination rules.

The invention enables the authentication of individuals, in particular in unprotected environments, for example,
on a computer, more specifically a home or corporate network,
n a smartphone or tablet computer,
at ATMs,
on websites (access to banking, forums, social networks, e-mail)
at entry/access control (e.g., door opener systems)
online banking (via Home Banking Computer Interface (HBCI))
in non-contact systems (e.g., money transfer via NFC—Near Field Communication or RFID systems),
household appliances (e.g., TV—as a child safety)
for vehicles (for example, an immobilizer)
the so-called “pairing” of devices (e.g., device coupling via Bluetooth)
so-called general “RADIUS” authentication.
as a verification query in call centers,
by logging in via OpenID, OpenID Connect or other authentication protocols,
as a replacement PIN to release functions in smart cards, such as the new identity card (NPA) or the new electronic health card (in Germany eGK).

An inventive apparatus for authenticating a person with respect a host can be used anywhere where a high degree of safety is required when entering passwords.

A host 1 may be a background system that is connected via a communication device 2 with a technical device 3, such as an end device or a remote terminal. The communication device 2 may be designed, for example, as a network, in particular a communications network, such as Internet or LAN network. The technical device 3 can thus be configured, for example, as a personal computer or a mobile phone or other portable or non-portable data device.

The host 1 may alternatively be formed as a terminal or as a terminal device.

The host 1 includes a processor 4 with a control unit and a memory by means of which the communication is controlled by the terminal 3.

The processing device 4 has on the one hand on a random number generator, by means of which a random-based information 5 of predetermined length consisting of numeric or alphanumeric characters is generated. Further, the processor 4 includes a memory, so that a plurality of algorithms can be stored as a secret password determination rules 6.1, 6.2, 6.3, 6.4.

The technical device or terminal 3 also has a control unit and a memory to enable communication with the host. Furthermore, the terminal 3 has an input/output unit (I/O) unit 7, by means of which information regarding a person can be displayed, and information can be entered through the same.

In order that the person may use services of the host 1, for example, access information stored on the host 1 or deposit or withdraw money or access to an area or a building, it is necessary that the person is authenticated or identified using the host.

To perform the authentication, a password request routine is carried out in accordance with FIG. 2 by the processing device 4. For example, if the person wants access to a building, a window is opened in the I/O unit 7 through terminal 3, in which the person can enter their user name in a name field 8. Alternatively, a credit card or the like can be inserted into a card slot of the I/O unit 7 or the process can be started via voice control.

The host 1 then generates random-based information 5, see step 10 in FIG. 2, which is then transmitted to the terminal 3 via the communication device. 2 The random-based information is then displayed in a random-based information field 12 of the I/O unit 7 in a step 11. Therewith a password request from the host is concluded.

The random-based information 5 is an alphanumeric sequence that is generated in the random number generator of the processing device 4. The random number generator is configured such that at each password request routine from a particular person a new random-based information 5 is always generated. In order to avoid that the same random-based information 5 will be communicated to the same person, it can be provided that the randomly-related information assigned to a person is stored, and at every random-based information generation checked if the current generated randomly-related information matches the stored random-based information. In case of a match, the current random-based information is discarded and new information is generated.

Following the completion of the password request carried out in steps 10, 11, in steps 13, 14 and 15, a password response occurs. In step 13, the person inputs into the field for random-based information 5 the secret password code 6.

FIG. 4 shows as an example a number of secret password determination rules 6, which are known only to the host 1 and the person. The secret password determination rule, which has been granted by the host 1 to a person for one or more services, has been sent to the person in a secured way in advance when setting up the service. The rules should preferably be a simple structure, so that the person can commit the rule to memory. Alternatively, the secret password determination rules could also be present on a piece of paper or media which the person may, where appropriate, quickly access.

A simple secret password determination rule 6.1 in FIG. 4 provides that the person determines the fifth and ninth number of random-based information 5 shown in the I/O unit 7, and enters this into a response section 16 of the I/O unit 7 in step 14. Subsequently, this temporary password will be sent directly to the host 1 in to step 15. In a verification step 17 is then carried out in the host 1, to determine whether the temporary password input by the person matches with the temporary password calculated by the host 1. Upon determination of a match, the person is allowed the access, see step 18. If no match has been found, the person is denied access to the service of host, see step 19.

In the FIG. 4 additional password determination rules 6.2, 6.3, 6.4 are shown.

For example, for each person, for a particular service, a predetermined secret password determination procedure assigned. Preferably, each person is assigned a predetermined secret password determination rule 6 for private use and another predetermined secret password determination rule 6 for business or professional use. Alternatively, each person could also, regardless of the purpose of use, be assigned a single predetermined secret password determination rule 6.

Alternatively, to increase security, it may be provided that for the access to the service by one person, multiple password rules 6 are used. With the provision of a single random-based information 5, multiple password rules known exclusively to the host and the person, but otherwise secret, result in different temporary passwords. Assuming that eavesdropping had been undertaken with the aim of reverse engineering the password determination rules using positive authentication samples (e.g., by re-engineering), this can be severely hampered by this concealment technique.

In the implementation of the random generator 5 for providing the password determination rule 6 the following parameters have to be considered:

| Parameter | Characteristic | Importance |
|---|---|---|
| Arithmetic | Out | Do not use calculations |
| | Easy | Subtraction/Addition/ |
| | | checksums/complement on ten |
| | Medium | Multiplication/Division |
| | Difficult | other mathematical functions |
| Letters | Out | Do not use letters |
| | Easy | Call letters at positions |
| | Medium | Simple arithmetic By J h |
| | | letters lead (next/previous letter |
| | | of the alphabet) |
| | Difficult | Arithmetic letter (letter in the |
| | | alphabet +/− 9) |
| Colors | Out | Do not use colors |
| | Easy | Color at position |
| | Medium | Complementary color to |
| | Difficult | position, color to number |
| | | assignments |
| Number of | Few | Has an impact on the number of |
| Operations | Mean Number | calculation steps needed. The |
| | Many | fewer, the simpler. |
| Simplified | None | Purely random positions are used |
| Selection of | Limit to all | Easy to recognize positions |
| Positions | triples or first, | are used (lower security) |
| | middle and last | |
| | position of | |
| | number triples | |
| Iterations | One | The result of a calculation is |
| | | used directly |
| | Two | The result of calculation goes |
| | | into a new calculation and is then |
| | | used |
| | Three | As above but with an |
| | | additional calculation step |
| Parallel | One | There is exactly one correct |
| Algorithms | | possible answer |
| | Two | There are 2 correct possible |
| | | answers |
| | Three | There are 3 correct possible |
| | | answer |

The random-based information 5, which is represented in the password request in the I/O unit 7, may consist of alphanumeric characters of different colors, namely for example:

| | | Additional info | Number/ | Additional info |
|---|---|---|---|---|
| Position | Letter | for letters | Color | for number |
| 1. | c | Lowercase/orange | 5 | Grey |
| 2. | j | Lowercase/blue | 0 | Blue |
| 3. | R | Capital/green | 0 | Pink |
| 4. | S | Capital/yellow | 6 | Orange |
| 5. | D | Capital/green | 4 | Grey |
| 6. | Z | Capital/brown | 3 | Magenta |
| 7. | b | Lowercase/red | 4 | Green |
| 8. | B | Capital/yellow | 8 | Yellow |
| 9. | T | Capital/green | 0 | Blue |
| 10. | L | Capital/blue | 5 | Black |
| 11. | A | Capital/green | 1 | Grey |
| 12. | c | Lowercase/red | 1 | Magenta |

If the host 1 is configured as a terminal, for example, as a mobile phone, with respect to which the person should identify himself, a local implementation of the secret password determination rule 6 in the mobile phone is required. To increase security, this password determination rule should be recorded on a chip of the mobile phone or in a portable data carrier of the person. The portable data carrier can be operated with contact and/or contactless and communicates with the mobile phone.

If the host 1 is a background system or a server, the communication occurs with the host 1 via the communication device 2, which is a data network. It is preferably carried out by encrypted transfer. The terminal 3 does not need to know the secret password determination rule 6. As long as the secret password determination rule is not known to a third person with intent to defraud, the person can authenticate, using the same user account, to different hosts 1, for example, a web page, a bank or a local network. A single secret determination rule 6 can be used to authenticate various requests of the person.

The secret password determination rule 6 could for example be stored in a standardized template or in a compilation of source code. For example, the secret password determination rule 6 can be stored in a Java Smart Card and only executed there.

The invention makes it possible in particular applications in public, since the temporary password input by the person is valid only temporarily, namely for only one password request routine. At the next password request routine another temporary password 20 is determined, which can for example be received by the I/O unit 7 by speech recognition. Alternatively the I/O unit 7 can be configured as a touch-sensitive screen (touch screen) to allow in a compact manner an input and output of information. Preferably, the screen is formed as a color display, so that colored characters can be used for the random-based information 5.

The random-based information 5 may alternatively be an information with random proportions without contain exclusively random information. Key for security is the secret selection of the information component necessary for calculating the temporary password. For example, the random-based information 5 can also contain weekday or dates and/or time information in addition to the random information.

The random-based information 5 may consist of numeric and/or alphanumeric characters and/or binary data and/or color code data.

The invention allows a simple and secure authentication, and in particular it allows:
Security against eavesdropping, keyloggers, Trojans, man-in-the-middle attacks
Voice input possible
Change of own password or change the password determination rules rarely necessary
No replay attacks possible
No additional hardware required
Only necessary to remember one algorithm (when using a central authentication service)

As can be seen from FIG. 4, the password determination provision 6.1 is comprised of a selection of one or more characters of the random-based information 5. The person need merely remember a certain number of places or positions of characters in the random-based information 5, and no combination of numbers. The input of the characters determined by the password determination rule 6.1 from the random character related information 5 then leads to a positive authentication result, which gives access. According to the password determination rule 6.2, 6.3, 6.4, this is determined by applying a simple mathematical rule to one or more strings of random-based information 5. In certain cases, a combination of the selection of one or more characters of the random-based information and the application of mathematical rules to one or more characters of the random-based information 5 can take place. This may depend on the person who agreed to a desired password determining rule with the host.

According to a further embodiment of the invention also an alarm rule can be applied to the random-based information 5 which is dependent on the password determination rule. If the person has received the random-based information from the host, by applying the alarm provision, for example, a modification of the password determination rule, for example, generating in reverse order the temporary password determined by the password determination rule, the host can be informed that there is an alarm. If the terminal of the person is for example an ATM, it can be communicated to the host in unrecognizable manner, that the ATM should be blocked. After verification of the alarm password sent to the host for agreement with the alarm password calculated by the host from the random-based information according to the predetermined alarm rule, the host can initiate or carry out the blocking of the ATM.

According to a further development of the invention an authenticity routine may be integrated into the authentication process, by means of which the authenticity of the host can be determined by the person. For this purpose, the host receives a corresponding authenticity request from the person. The random based information 5 message sent by the host to the person is modified so that it contains a user-related authenticity feature, so that the person can verify the authenticity from the available random-based information in a first step. The verifying of the authenticity occurs by means of user-specific authenticity rules which are known exclusively by the host and the person. The host has modified the randomly related information 5 in accordance with this authentication rule and sent this to this person. The person applies the authentication rule to the the random-based information 5 and obtains a result, which result is compared against the received authenticity result for authenticity. If these two results match, the authenticity of the host is verified to the person.

As the authenticity rule, there may be provided, e.g., that in the response of the host, the random-based information 5 will always contain three blue figures. Alternatively, the user-related provision authenticity have a check-sum of 12 in the last number triple. The user-based authenticity rule may contain e.g. rules, as indicated in FIG. 4 for password determination rules. It is only necessary that the password determination rule and the authentication rule differ from one another.

The user-based authentication rule may be formed by a selection of one or more characters of the random-based information 5, and/or by applying a mathematical procedure to one or more characters of the random-based information 5.

The request of the person to the host can be done by transmitting a user identification, such as for example, as conventional in e-mail traffic. Once the authenticity of the host has been confirmed by the person, then, by entry of the temporary password, the communication with the host or any other person may be take place.

1. A method for authenticating a person with respect to a host, comprising
the host requesting a temporary password from the person for access to a service of the host,
the host generating a random-based information and making this available to the person on a communication device as an input value for an algorithm, from which the temporary password is calculated, wherein the same algorithm is used by the person and the host to determine the password, and
the host determining conformity and after verification of conformity between the password as determined by the person and as determined by the host,
the host granting the person access to the service of the host,
wherein the random-based information (5) is displayed to the person as part of a password request routine of the host (1) and
wherein the person responds with a temporary password (20),
wherein only the random-based information (5) is used as an input variable for the temporary password (20) determined by a secret algorithm (6, 6.1, 6.2, 6.3, 6.4).

2. The method of claim 1, wherein during the password request routine first a password request is made from the host (1) to the person, wherein the random-based information (5) is displayed, and wherein after a password response is carried out by the person, the temporary password (20) is received by the host (1).

3. The method of claim 1, wherein on the one hand via the communication means (2) only the random-based information (5) is transmitted from the host (1) to an input/output unit (7) and on the other hand only the temporary password (20) is transmitted from the input/output unit (7) to the host.

4. The method according to claim 1, wherein the algorithm is provided to the person as secret password determination rule (6, 6.1, 6.2, 6.3, 6.4) prior to the password request routine.

5. The method according to claim 1, wherein, for each password request routine of a specific person, in each case a different random number generated by means of a random-based information (5) is supplied.

6. A device for authenticating a person with respect to a host, with a processor, by means of which in the host an algorithm is applied to the random-based information to determine a temporary password,
wherein the algorithm is previously known to the person as a secret password determination rule (6, 6.1, 6.2, 6.3, 6.4) and wherein the password determination rule (6, 6.1, 6.2, 6.3, 6.4) is selected such that the temporary password (20) can be determined using the password determination rule (6, 6.1, 6.2, 6.3, 6.4) solely from the random-based information (5).

7. The device according to claim 5, wherein the password determination rule (6, 6.1, 6.2, 6.3, 6.4) is a freely selectable rule referenced on numeric and/or alphanumeric characters and/or binary data and/or color code data, which can be applied to arbitrary sequences of numeric and/or alphanumeric characters and/or binary data and/or color code data.

8. The device according to claim 6, wherein the password determination rule (6, 6.1, 6.2, 6.3, 6.4) provides for the selection of one or more characters of the random-based information (5) and/or by application of a mathematical procedure to one or more characters of the random-based information (5).

9. The device according to claim 7, wherein the password determination rule (6, 6.1, 6.2, 6.3, 6.4) is selected so that the determined temporary password (20) has a maximum length of four alpha-numeric or numeric characters.

10. The device according to claim 6, wherein a set of password determination rules (6, 6.1, 6.2, 6.3, 6.4) is stored in the processor (4) of the host (1), wherein each person is permanently assigned one of these password determination rules (6, 6.1, 6.2, 6.3, 6.4), independent of the service to be used.

11. The device according to claim 6, wherein the I/O unit is integrated in a terminal device, in particular in a terminal or a mobile phone, and that a communication device is provided for sending a random-based information from the host to the person.

12. The device according to claim 6, wherein by applying an alarm rule to the random-based information (5), which alarm rule is dependent upon the password determination rule (6, 6.1, 6.2, 6.3, 6.4), an alarm password can be determined, so after checking the alarm password with a user-specific predefined alarm password, which is dependent upon the password determination rule (6, 6.1, 6.2, 6.3, 6.4), the terminal, from which person sent the alarm password, is blocked by the host (1).

13. The device according to claim 6, wherein the random based information (5) sent from the host (1) to the person in response to a request is designed such that, from it, supplementally, using a user-based authentication rule, which is known to only the host (1) and the person, an authenticity result is determined, so that in the case of a match with a predetermined authenticity outcome, the authenticity of the host (1) towards the person is satisfied.

14. The device according to claim 6, wherein the inquiry of the person to the host (1) takes place by transmitting a user ID to the host (1), so that the random-based information generated by the host (5) is generated or modified so that the randomly related information (5) message sent to the person meets the user-based authenticity rule.

15. The device according to claim 6, wherein the person is a client who authenticates with respect to the host (1) by entering the user ID and the temporary password (20).
